(19) United States
(12) Patent Application Publication
(10) Pub. No.: US 2023/0264291 A1
(43) Pub. Date: Aug. 24, 2023

(54) Welding System and Welding Method

(71) Applicants: Tyco Electronics (Shanghai) Co., Ltd., Shanghai (CN); TE Connectivity Services GmbH, Schaffhausen (CH)

(72) Inventors: Zongjie (Jason) Tao, Shanghai (CN); Dandan (Emily) Zhang, Shanghai (CN); Roberto Francisco-Yi Lu, Bellevue, WA (US)

(73) Assignees: Tyco Electronics (Shanghai) Co., Ltd., Shanghai (CN); TE Connectivity Services GmbH, Schaffhausen (CH)

(21) Appl. No.: 18/171,933

(22) Filed: Feb. 21, 2023

(30) Foreign Application Priority Data
Feb. 21, 2022 (CN) 202210156442.X

(51) Int. Cl. B23K 26/03; B23K 26/21

(52) U.S. Cl. CPC B23K 26/032; B23K 26/21

(57) ABSTRACT

A welding system for welding a wire to a welding pad includes a moving device movable in at least two directions, a welding head mounted on the moving device and a visual devise. The welding head is adapted to clamp the wire. The visual device guides the moving device to move the welding head to a predetermined position. In operation, the moving device moves the welding head to a clamping position aligned with the wire, and moves the clamped wire to a welding position aligned with the welding pad under the guidance of the visual device.

### CROSS-REFERENCE TO RELATED APPLICATIONS

This application claims the benefit of Chinese Patent Application No. CN202210156442.X filed on Feb. 21, 2022 in the State Intellectual Property Office of China, the whole disclosure of which is incorporated herein by reference.

### FIELD OF THE INVENTION

The present invention relates to a welding system and a welding method for welding a wire to a welding pad.

### BACKGROUND

When manufacturing communication products, it is often necessary to weld a wire to a welding pad. In order to ensure high-speed data transmission, high welding accuracy must be ensured between the wire and the welding pad. In the prior art, in order to align the wire with the welding pad, a fixture is typically used to clamp and align the wire and the welding pad. However, with the miniaturization of communication products, the diameter of the wires to be welded are becoming increasingly smaller. As a result, it is difficult to ensure the accurate alignment of the wire and the welding pad via a fixture, which leads to a positioning error between the wire and the welding pad.

Improved systems and methods addressing these issues are required.

### SUMMARY

According to an embodiment of the present disclosure, a welding system for welding a wire to a welding pad includes a moving device movable in at least two directions, a welding head mounted on the moving device and a visual devise. The welding head is adapted to clamp the wire. The visual device guides the moving device to move the welding head to a predetermined position. In operation, the moving device moves the welding head to a clamping position aligned with the wire, and moves the clamped wire to a welding position aligned with the welding pad under the guidance of the visual device.

### BRIEF DESCRIPTION OF THE DRAWINGS

The invention will now be described by way of example with reference to the accompanying Figures, of which:

FIG. 1 is a schematic diagram of a welding system according to an exemplary embodiment of the present invention;

FIG. 2 is a schematic diagram of a vertical moving module of a welding system according to an exemplary embodiment of the present invention;

FIG. 3 is a schematic diagram of a horizontal moving module of a welding system according to an exemplary embodiment of the present invention;

FIG. 4 is a schematic diagram in which a welding head is located in a position that is not aligned with a conductor;

FIG. 5 is a schematic diagram in which the welding head is moved to a clamping position aligned with a wire to be welded; and

FIG. 6 is a schematic diagram of moving the clamped wire to a welding position aligned with a welding pad by the welding head.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a welding system comprises a moving device capable of moving in at least two different directions. A welding head is mounted on the moving device and moves therewith. A visual device of the system provides visual guidance for the moving device to move the welding head to a predetermined position by the moving device. The welding head is adapted to clamp a wire to be welded. The moving device is adapted to move the welding head to a clamping position aligned with the wire, and move the clamped wire to a welding position aligned with a welding pad under the guidance of the visual device.

According to another embodiment of the present disclosure, a welding method comprises steps of: 1) providing the above described welding system; 2) using the visual device to identify the position of a wire to be welded; 3) moving the welding head to a clamping position aligned with the wire by the moving device and clamping the wire by the welding head; 4) using the visual device to identify the position of a welding pad; and 5) moving the clamped wire to a welding position aligned with a welding pad by the moving device and welding the wire onto the welding pad by the welding head.

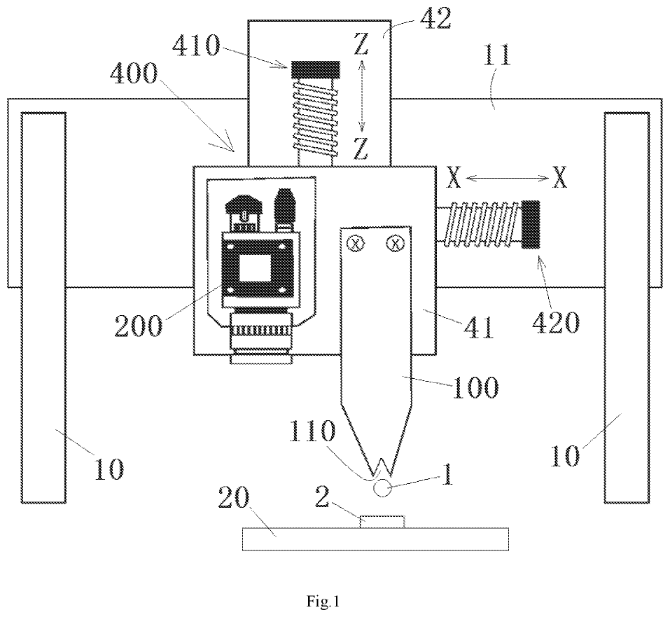

FIG. 1 is a schematic diagram of a welding system according to an exemplary embodiment of the present invention. As shown in FIG. 1, the welding system is used to weld a wire or conductor 1 to a welding pad 2 of an electronic product 20. The electronic product 20 may be, for example, a circuit board or a chip. The welding system comprises a welding head 100, a visual device 200 and a moving device 400.

The welding head 100 can be a laser welding head or a soldering iron head. A V-shaped groove 110 is formed on the end of the welding head 100. The V-shaped groove 110 extends a predetermined length along the axial direction of the wire 1 and is adapted to clamp the wires 1 with different diameters. The moving device 400 can move in at least two different directions X,Z. The welding head 100 is mounted on the moving device 400 an is movable therewith along the at least two different directions X,Z. The visual device 200 provides the moving device 400 with visual guidance to move the welding head 100 to a predetermined position via the moving device 400.

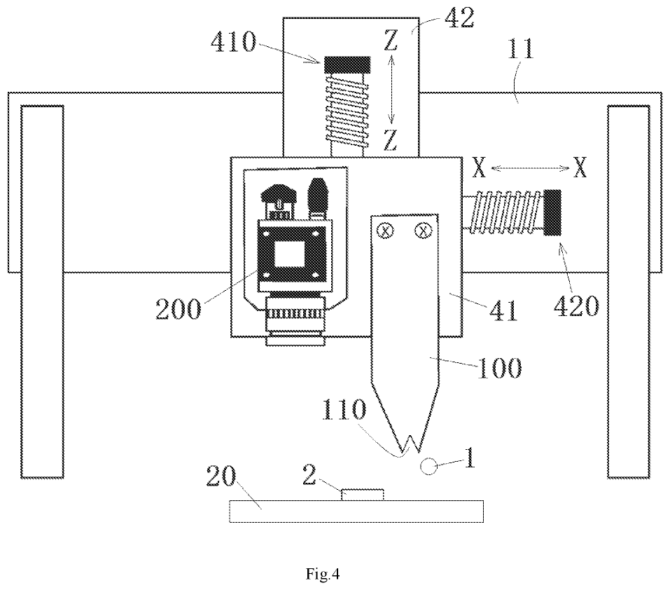

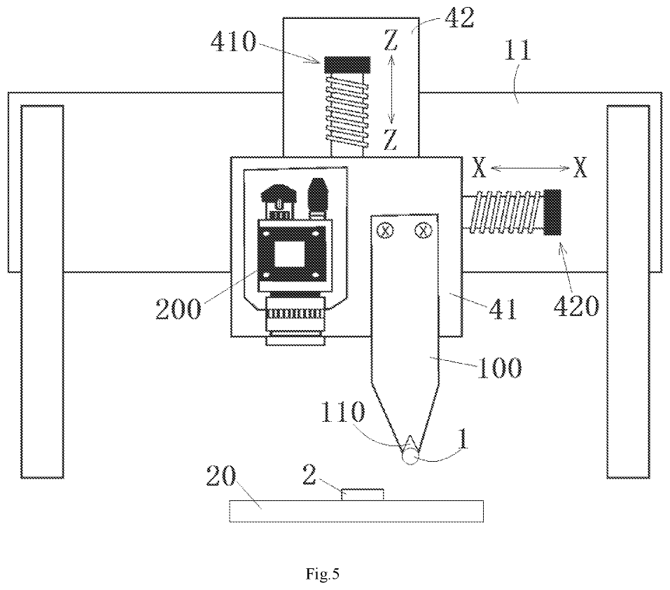

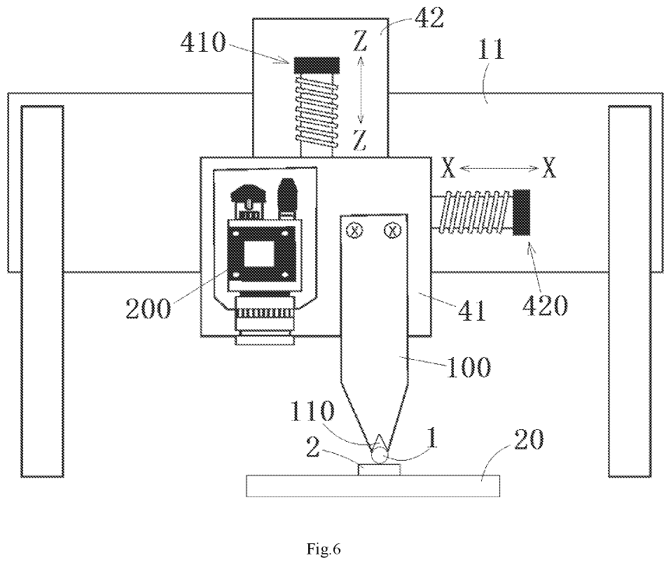

FIG. 4 is a schematic diagram in which the welding head 100 is located at a position that is not aligned with the wire 1. FIG. 5 is a schematic diagram in which the welding head 100 is moved to a clamping position aligned with the wire 1. And FIG. 6 is a schematic diagram of moving the clamped wire 1 to the welding position aligned with the welding pad 2 by the welding head 100. As shown in FIGS. 1 and 4-6, the welding head 100 is suitable for clamping the wire or conductor 1. The moving device 400 is adapted to move the welding head 100 to the clamping position aligned with the wire 1 and move the clamped wire 1 to the welding position aligned with the welding pad 2 under the guidance of the visual device 200.

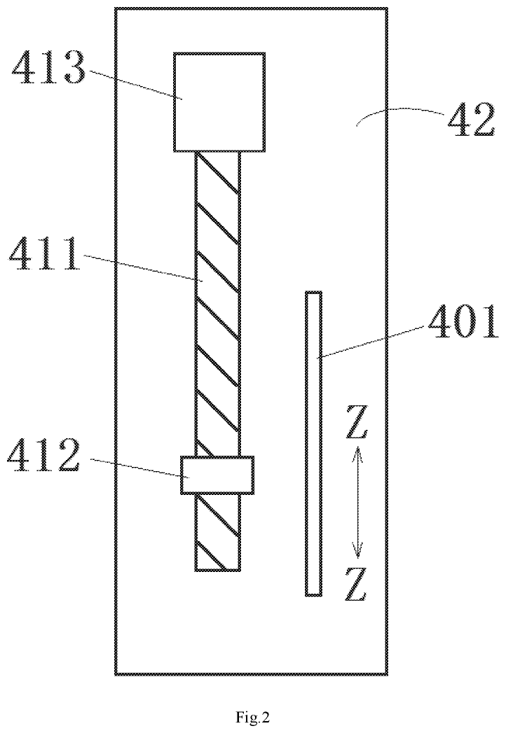

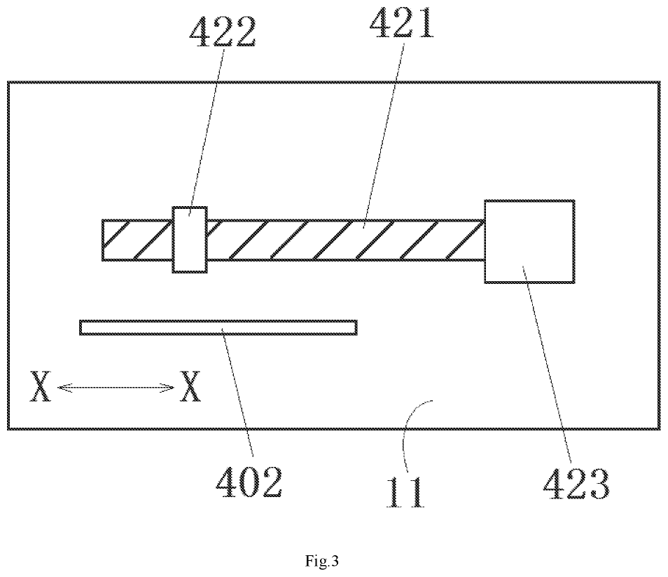

FIG. 2 is a schematic diagram of a vertical moving module of a welding system according to an exemplary embodiment of the present invention. FIG. 3 is a schematic diagram of a horizontal moving module of a welding system according to an exemplary embodiment of the present invention. As shown in FIGS. 1-6, the moving device 400 may be a translation mechanism (as shown), a robot or a mechanical arm capable of moving in the at least two different directions X,Z. The moving device 400 includes a vertical moving module 41,410 and a horizontal moving module 42420. The vertical moving module 41,410 is movable in the vertical direction Z. The horizontal moving module 42,420 is movable in the horizontal direction X. The welding head 100 is installed on one of the vertical moving module 41,410 or the horizontal moving module 42,420.

In the exemplary embodiment, the vertical moving module 41,410 is installed on the horizontal moving module 42,420 to move along the horizontal direction X with the horizontal moving module. The welding head 100 is installed on the vertical moving module 41,410 to move along the vertical direction Z with the vertical moving module.

However, the present invention is not limited to the illustrated embodiments. In another exemplary embodiment of the present invention, the horizontal moving module 42,420 is installed on the vertical moving module 41,410 to be able to move along the vertical direction Z with the vertical moving module. Likewise, the welding head 100 is installed on the horizontal moving module 42,420 to move along the horizontal direction X with the horizontal moving module.

The welding system also includes a bracket 10, which has a support plate 11 extending in the horizontal direction X and vertical direction Z. The moving device 400 is installed on the support plate 11 of the bracket 10.

The vertical moving module 41,410 includes a first movable plate 41 and a first driving device 410. The first driving device 410 is used to drive the first movable plate 41 to move in the vertical direction Z. The horizontal moving module 42,420 includes a second movable plate 42 and a second driving device 420. The second driving device 420 is used to drive the second movable plate 42 to move in the horizontal direction X.

The welding head 100 is installed on the first movable plate 41. The first movable plate 41 and the first driving device 410 are mounted on the second movable plate 42. The second movable plate 42 and the second driving device 420 are installed on the support plate 11.

The first driving device 410 includes a first lead screw 411, a first nut 412, and a first motor 413. The first lead screw 411 is rotatably mounted on the second movable plate 42. The first nut 412 is threaded with the first lead screw 411 and fixed to the first movable plate 41. The first motor 413 is fixed on the second movable plate 42 to drive the first lead screw 411 to rotate.

The second driving device 420 includes a second lead screw 421, a second nut 422 and a second motor 423. The second lead screw 421 is rotatably mounted on the support plate 11. The second nut 422 is threaded with the second lead screw 421 and fixed to the second movable plate 42. The second motor 423 is fixed on the support plate 11 to drive the second lead screw 421 to rotate.

One of the first movable plate 41 or the second movable plate 42 is provided with a first sliding rail 401 extending in the vertical direction Z, and the other is provided with a first sliding block suitable for sliding fit with the first sliding rail 401. The first movable plate 41 is slidably mounted on the second movable plate 42 by the first sliding rail 401 and the first sliding block.

One of the support plate 11 or the second movable plate 42 is provided with a second sliding rail 402 extending in the horizontal direction X, and the other is provided with a second sliding block suitable for sliding fit with the second sliding rail 402. The second movable plate 42 is slidably mounted on the support plate 11 by the second sliding rail 402 and the second sliding block.

Both the visual device 200 and the welding head 100 are installed on the first movable plate 41, such that the visual device 200 and the welding head are moved together. The visual device 200 may be a camera, and the welding head 100 is located in the field of view of the visual device.

A welding method for welding the wire 1 to the welding pad 2 by the aforementioned welding system will be described below with reference to the drawings. The welding method includes the following steps of:

S100: providing the welding system as shown in FIG. 1;

S200: using the visual device 200 to identify the position of wire 1 to be welded;

S300: as shown in FIG. 4 and FIG. 5, moving the welding head 100 to the clamping position aligned with the wire 1 through the moving device 400 and clamping the wire by the welding head;

S400: using the visual device 200 to identify the position of welding pad 2; and

S500: as shown in FIG. 5 and FIG. 6, moving the clamped wire 1 to the welding position aligned with the welding pad 2 through the moving device 400 and welding the wire onto the welding pad by the welding head 100.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A welding system for welding a wire to a welding pad, comprising:
a moving device movable in at least two different directions;
a welding head mounted on the moving device and movable therewith, the welding head adapted to clamp the wire; and
a visual device guiding the moving device to move the welding head to a predetermined position, the moving device moving the welding head to a clamping position aligned with the wire and moving the clamped wire to a welding position aligned with the welding pad under the guidance of the visual device.

2. The welding system according to claim 1, wherein the moving device includes:
a vertical moving module movable in a vertical direction; and
a horizontal moving module movable in a horizontal direction.

3. The welding system according to claim 2, wherein the welding head is mounted on one of the vertical moving module or the horizontal moving module.

4. The welding system according to claim 3, wherein the vertical moving module is mounted on the horizontal moving module and movable in the horizontal direction with the horizontal moving module, and the welding head is mounted on the vertical moving module and movable along the vertical direction with the vertical moving module.

5. The welding system according to claim 3, wherein the horizontal moving module is mounted on the vertical moving module and movable along the vertical direction with the vertical moving module, and the welding head is mounted on the horizontal moving module and movable along the horizontal direction with the horizontal moving module.

6. The welding system according to claim 3, further comprising a bracket including a support plate extending in the horizontal direction and the vertical direction, the moving device mounted on the support plate of the bracket.

7. The welding system according to claim 6, wherein the vertical moving module includes:
a first movable plate; and
a first driving device for driving the first movable plate to move in the vertical direction.

8. The welding system according to claim 7, wherein the horizontal moving module includes:
a second movable plate; and
a second driving device for driving the second movable plate to move in the horizontal direction.

9. The welding system according to claim 8, wherein:
the welding head is mounted on the first movable plate;
the first movable plate and the first driving device are mounted on the second movable plate; and
the second movable plate and the second driving device are mounted on the support plate.

10. The welding system according to claim 9, wherein the first driving device includes:
a first lead screw rotatably mounted on the second movable plate;
a first nut threaded with the first lead screw and fixed to the first movable plate; and
a first motor fixed on the second movable plate and driving the first lead screw to rotate.

11. The welding system according to claim 10, wherein the second driving device includes:
a second lead screw rotatably mounted on the support plate;
a second nut threaded with the second lead screw and fixed to the second movable plate; and
a second motor fixed on the support plate and driving the second lead screw to rotate.

12. The welding system according to claim 9, wherein the first movable plate is slidably mounted to the second movable plate.

13. The welding system according to claim 12, wherein one of the first movable plate or the second movable plate includes a first sliding rail extending in the vertical direction, and the other of the first movable plate or the second movable plate is slidingly fit with the first sliding rail.

14. The welding system according to claim 13, wherein the second movable plate is slidably mounted on the support plate.

15. The welding system according to claim 14, wherein one of the support plate or the second movable plate includes a second sliding rail extending in the horizontal direction, and the other one of the support plate or the second movable plate is slidingly fit with the second sliding rail.

16. The welding system according to claim 9, wherein the visual device and the welding head are mounted on the first movable plate such that the visual device and the welding head are moved together.

17. The welding system according to claim 1, wherein the welding head is a laser welding head or a soldering iron head.

18. The welding system according to claim 1, wherein the moving device is a translation mechanism, a robot or a mechanical arm movable in at least two different directions.

19. The welding system according to claim 1, wherein a V-shaped groove is formed on an end of the welding head and extends a predetermined length along an axial direction of the wire, the welding head and the V-shaped groove are adapted to clamp wires of different diameters.

20. A welding method using a welding system, comprising steps of:
identifying a position of a wire to be welded with a visual device of the system;
moving a welding head of the system to a clamping position aligned with the wire with a moving device of the system;
clamping the wire with the welding head;
identifying a position of a welding pad with the visual device;
moving the clamped wire to a welding position aligned with a welding pad with the moving device; and
welding the wire onto the welding pad with the welding head.
